(19) United States
(12) Patent Application Publication
(10) Pub. No.: US 2016/0114526 A1
(43) Pub. Date: Apr. 28, 2016

(54) METHOD OF CONNECTING MEMBERS

(71) Applicant: TOYOTA JIDOSHA KABUSHIKI KAISHA, Toyota-shi (JP)

(72) Inventor: Takashi INOH, Okazaki-shi (JP)

(73) Assignee: TOYOTA JIDOSHA KABUSHIKI KAISHA, Toyota-shi (JP)

(21) Appl. No.: 14/887,993

(22) Filed: Oct. 20, 2015

(30) Foreign Application Priority Data
Oct. 24, 2014 (JP) 2014-217218

(51) Int. Cl. B29C 65/70; B29C 70/42; B29C 70/54; B29C 70/06

(52) U.S. Cl. CPC B29C 65/70; B29C 70/06; B29C 70/42; B29C 70/541; B29K 2101/12

(57) ABSTRACT

A method of connecting members includes: preparing a mold including an upper mold and a lower mold, the upper mold or the lower mold forming a cavity provided with a recess; disposing a fiber-reinforcing material in the cavity, filling the cavity and the recess with a thermoplastic resin, and curing the thermoplastic resin to produce a resin-molded composite member including a fiber-reinforced resin molded body and a resin molded body, the resin molded body being integrated with the fiber-reinforced resin molded body, and the resin molded body including no fiber-reinforcing material; and inserting the resin molded body through a through-hole of a predetermined member, and deforming the resin molded body with pressure to clamp the predetermined member by the fiber-reinforced resin molded body and the resin molded body and to connect the resin-molded composite member and the predetermined member.

### INCORPORATION BY REFERENCE

The disclosure of Japanese Patent Application No. 2014-217218 filed on Oct. 24, 2014 including the specification, drawings and abstract is incorporated herein by reference in its entirety.

### BACKGROUND OF THE INVENTION

1. Field of the Invention

The present invention relates to a connecting method of connecting a resin-molded member and a different member, at least part of the resin-molded member including a fiber-reinforcing material.

2. Description of Related Art

Fiber-reinforced resin members (fiber-reinforced plastics (FRP)), formed of resin and reinforcing fiber materials contained in the resin (fiber-reinforcing materials), are used in various industrial fields, such as an automotive industry, a construction industry, and an aviation industry because of light weight and high strength thereof. For example, in the automotive industry, the aforementioned fiber-reinforced resin members are applied to frame structural members of vehicles, such as front side members, center cross members, pillars, lockers, and floors of the bodies, or applied to non-structural members where designing properties are required, such as door outer panels and hoods. With the aforementioned configuration, various efforts have been made to reduce weights of vehicles while ensuring strength of the vehicles so as to manufacture environment-friendly vehicles with an enhanced fuel-efficiency.

As a method of connecting fiber-reinforced resin members, there is commonly employed a connecting method using adhesive, or a connecting method using bolts, or a combination of these methods. Meanwhile, as a method of connecting metallic members, such as aluminum plates and steel plates, there is commonly employed a connecting method through spot welding, friction-stir welding, mechanical clinching, brazing, screwing, self-pierce riveting, or the like. Self-pierce riveting is disclosed in Japanese Patent Application Publication No. 2007-229980, for example. With respect to connection between a fiber-reinforced resin member and a metallic member, that is, connection between members of different types, the members are connected to each other using one of the aforementioned methods, or in combination of two or more of the aforementioned methods in some cases.

Both in a connection between fiber-reinforced resin members, or between metallic members, that is, a connection between so-called similar members, and in a connection between a fiber-reinforced resin member and a metallic member, that is, a connection between so-called dissimilar members, the aforementioned connecting methods have various problems.

For example, in the case of using adhesive, it takes some time to bond the members. In the case of using bolts, screwing, self-pierce riveting, or the like, connecting components are required, and thus manufacturing time becomes increased, or manufacturing cost associated with the connecting components becomes increased.

Particularly, in the case of connecting members having three-dimensionally complicated shapes to each other using connecting components, such as bolts, it is not easy to handle alignment between the members to be connected; thus it is likely to require more assembly procedures to connect the members to each other using the connecting components. In connection through adhesive or welding, it is difficult to apply adhesive to, or apply heat to the entire portions (overlaid portions) to be connected that are three-dimensionally complicated as uniformly as possible.

### SUMMARY OF THE INVENTION

The present invention provides a connecting method of connecting a resin-molded member and a different member, at least part of the resin-molded member including a fiber-reinforcing material.

A first aspect of the present invention is a method of connecting members. The method includes: preparing a mold including an upper mold and a lower mold by both of which a cavity is formed, a cavity surface of the upper mold or the lower mold having a recess, and the cavity surface facing the cavity; disposing a fiber-reinforcing material formed of a continuous-fiber-reinforcing material or a long-fiber-reinforcing material in the cavity, filling the cavity and the recess with a thermoplastic resin, and curing the thermoplastic resin to produce a resin-molded composite member including a fiber-reinforced resin molded body and a resin molded body, the fiber-reinforced resin molded body being formed of the fiber-reinforcing material and the thermoplastic resin, the resin molded body being integrated with the fiber-reinforced resin molded body, and the resin molded body including no fiber-reinforcing material; and inserting the resin molded body through a through-hole of a predetermined member, and deforming the resin molded body with pressure to clamp the predetermined member by the fiber-reinforced resin molded body and the resin molded body and to connect the resin-molded composite member and the predetermined member.

According to the first aspect of the present invention, because the resin molded body to be deformed includes no fiber-reinforcing material such as a continuous-fiber-reinforcing material, pressurizing deformation (including pressurizing deformation in a state in which the resin is heated and melted) becomes easier, thus facilitating clamping between the members. No connecting components, such as adhesive, bolts, screws, and self-pierce rivets, are required in connection between the two members, thus enhancing efficiency of connecting work as well as attaining reduction in manufacturing cost. Basically, it is unnecessary to use adhesive and connecting components, but this does not mean that usage of these components is completely eliminated. For example, adhesive and or connecting components may be used at the same time for the purpose of enhancing connecting strength if necessary.

The “cavity surface of the upper mold or the lower mold having a recess” means that at least one of the upper mold and the lower mold includes at least one recess. Specifically, depending on the connecting positions or the number of connecting positions between the resin-molded composite member to be molded and a predetermined member (also referred to as a different member, hereinafter), it may be configured to set positions of or the number of the recesses to be provided to the respective cavity surfaces of the upper mold and the lower mold. The shape of the recess may be any shape as far as the resin molded body to be molded can be inserted through the through-hole of the different member, and can be deformed with pressure to clamp the different member. For example, the recess may be a cylindrical groove or a groove in a polygonal pillar shape.

The “continuous-fiber-reinforcing material” is defined as a fiber material whose fiber length is more than 50 mm, as specified by the Japanese Industrial Standards (JIS), which is collected into a predetermined shape (e.g., three-dimensional shape approximate to the shape of the fiber-reinforced resin molded material to be molded). The “long-fiber-reinforcing material” is defined as a fiber material having a fiber length shorter than that of the continuous-fiber-reinforcing material, specifically, a fiber length within a range of less than 50 mm to more than 10 mm, which is collected into a predetermined shape. These fiber-reinforcing materials may be formed by using one of carbon fibers, metallic fibers, and ceramic fibers, or a mixture of two or more of them.

Since the continuous-fiber-reinforcing material and the long-fiber-reinforcing material have long fiber lengths, and enhance strength of the member, it is not easy to deform, with pressure, a resin member including such a fiber-reinforcing material. To counter this, in the first aspect of the present invention, the recess in a predetermined dimension and in a predetermined shape is disposed at a predetermined position of the cavity surface of the upper mold or the lower mold. Furthermore, in the first aspect of the present invention, the cavity and the recess are filled with the thermoplastic resin without disposing the fiber-reinforcing material in this recess.

The resin-molded composite member produced by the first aspect of the present invention includes: the fiber-reinforced resin molded body formed of the fiber-reinforcing material and the thermoplastic resin; and the resin molded body integrated with the fiber-reinforced resin molded body, without including the fiber-reinforcing material, thus being easily deformed with pressure.

“Filling with a thermoplastic resin” may be conducted by an injection-molding method of the thermoplastic resin. Alternatively, “filling with a thermoplastic resin” may include disposing mass of the thermoplastic resin or the like in the cavity and then molding the thermoplastic resin with pressure at the time of clamping the mold so that the thermoplastic resin spreads across the entire cavity and the recess.

The thermoplastic resin to be applied may be a crystalline plastic such as polyamide (PA) and polypropylene (PP), and an amorphous plastic such as polystyrene (PS) and polyvinyl chloride (PVC).

In the first aspect of the present invention, for example, there is produced the resin-molded composite member configured such that a protrusive resin molded body projecting from a planar fiber-reinforced resin molded body. The resin molded body including no fiber-reinforcing material is inserted through the through-hole of the predetermined member (different member), and is then deformed with pressure. As the “predetermined member”, various members may be employed, such as a fiber-reinforced resin member the entire or part of which includes the fiber-reinforcing material as similar to the resin-molded composite member, a resin member including no fiber-reinforcing material, a metallic member made of aluminum alloy, iron, or the like, or a concrete member made of RC, SRC, or the like.

In the first aspect of the present invention, the processing method of deforming the resin molded body with pressure may be a method of deforming the resin molded body through pressing, or a method of thermally deforming the resin molded body through pressing at least in a state in which the resin molded body is heated and softened. With respect to the thermal deforming method, the resin molded body is pressurized under a temperature atmosphere at a melting point or more of a polymerized thermoplastic resin, thereby easily performing pressurizing deformation of the resin molded body.

A second aspect of the present invention is a method of connecting members. The method includes: preparing a mold including an upper mold and a lower mold by both of which a cavity is formed, a cavity surface of the upper mold or the lower mold having a recess, and the cavity surface facing the cavity; disposing a first fiber-reinforcing material formed of a continuous-fiber-reinforcing material or a long-fiber-reinforcing material in the cavity, disposing a second fiber-reinforcing material formed of a short-fiber-reinforcing material in the recess, filling the cavity and the recess with a thermoplastic resin, and curing the thermoplastic resin to produce a resin-molded composite member including a first fiber-reinforced resin molded body and a second fiber-reinforced resin molded body, the first fiber-reinforced resin molded body being formed of the first fiber-reinforcing material and the thermoplastic resin, the second fiber-reinforced resin molded body being integrated with the first fiber-reinforced resin molded body, and the second fiber-reinforced resin molded body being formed of the second fiber-reinforcing material and the thermoplastic resin; and inserting the second fiber-reinforced resin molded body through a through-hole of a predetermined member, and deforming the second fiber-reinforced resin molded body with pressure to clamp the predetermined member by the first fiber-reinforced resin molded body and the second fiber-reinforced resin molded body and to connect the resin-molded composite member and the predetermined member.

The “short-fiber-reinforcing material” is defined as a fiber material having a fiber length shorter than that of the long fiber material, specifically, a fiber length of 10 mm or less, which is collected into a predetermined shape (shape to be disposed in the recess).

The second fiber-reinforced resin molded body to be inserted through the through-hole of the predetermined member (different member) and deformed contains the fiber-reinforcing material thereinside, but this fiber-reinforcing material is a short-fiber-reinforcing material. Accordingly, the second fiber-reinforced resin molded body can be more easily deformed with pressure compared with the first fiber-reinforced resin molded body. The second fiber-reinforced resin molded body to be inserted through the through-hole of the different member and deformed contains the fiber-reinforcing material, thus further enhancing the connecting strength between the different member and the resin-molded composite member.

According to the first and second aspects of the present invention, the resin molded body or the second fiber-reinforced resin molded body to be deformed includes no continuous-fiber-reinforcing material or no long-fiber-reinforcing material, thus facilitating pressurizing deformation, and facilitating clamping between the members. In addition, it is unnecessary to use connecting components, such as adhesive, bolts, screws, and self-pierce rivets when the two members are connected to each other; therefore, it is possible to enhance efficiency of the connecting work as well as attain reduction in manufacturing cost.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A, FIG. 1B, and FIG. 1C are drawings showing a first step of a method of connecting members that is a first embodiment of the present invention, and showing examples of molds used in the first step;

FIG. 2 is a drawing showing a part of a second step of the method of connecting the members that is the first embodiment of the present invention;

FIG. 3 is a drawing showing a part of the second step continued from FIG. 2;

FIG. 4 is a schematic drawing showing a resin-molded composite member produced in the second step;

FIG. 5 is a drawing showing a third step of the method of connecting the members that is the first embodiment of the present invention;

FIG. 6 is a schematic drawing showing a connected structural body produced in the first embodiment of the present invention;

FIG. 7 is a drawing showing a second step of a method of connecting members that is a second embodiment of the present invention;

FIG. 8 is a schematic drawing showing a resin-molded composite member produced in the second step of the second embodiment of the present invention; and

FIG. 9 is a schematic drawing showing a connected structural body produced in the second embodiment of the present invention.

### DETAILED DESCRIPTION OF EMBODIMENTS

A method of connecting members that is the first embodiment of the present invention will be described with reference to drawings, hereinafter. In examples illustrated in the drawings, a resin-molded composite member and a metallic member that is a different member (predetermined member) are treated as connecting targets, but the first embodiment of the present invention is not limited to this. For example, in the case of connecting resin-molded composite members to each other, one of the resin-molded composite members may be treated as a different member having a through-hole. In the case of connecting a resin-molded composite member and resin-molded body including no fiber-reinforcing material, the resin-molded boy may be treated as a different member having a through-hole. In the case of connecting a resin-molded composite member and a concrete member, the concrete member may be treated as a different member having a through-hole. In the examples illustrated in the drawings, the metallic member that is a different member is connected to a surface on one side (top surface) of the resin-molded composite member, but the first embodiment of the present invention is not limited to this. For example, a metallic member may be connected to the surface on one side of the resin-molded composite member, and a metallic member, a resin-molded composite member, or the like that is a different member is connected to a surface on the other side (bottom surface) of the resin-molded composite member. Furthermore, a connecting surface between the resin-molded composite member and the different member is not limited to a planar surface as exemplified in the drawings, and may also be a three-dimensional shape, such as a curved shape and a wavy shape.

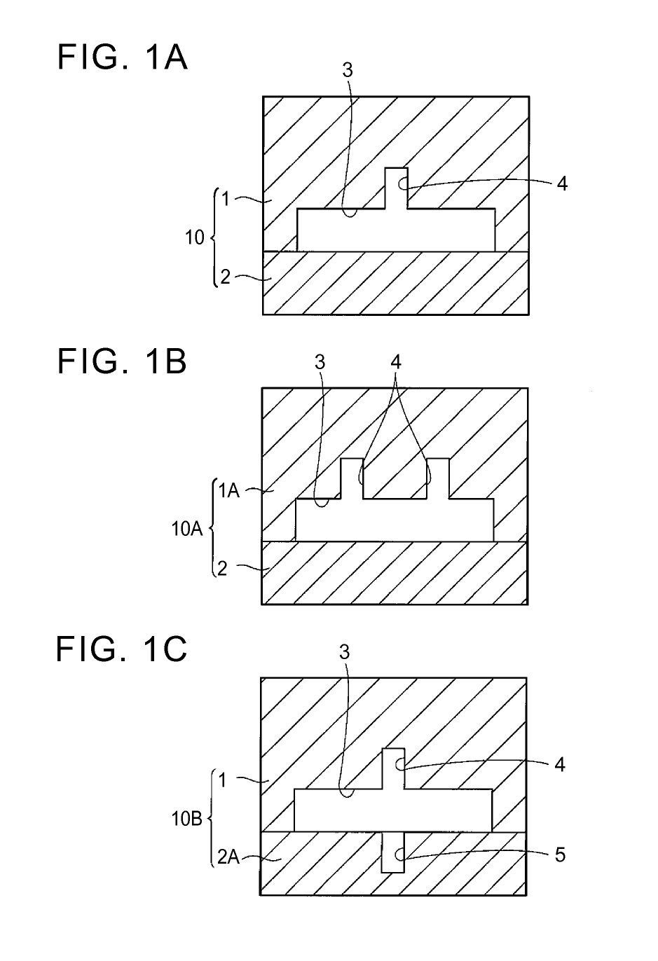

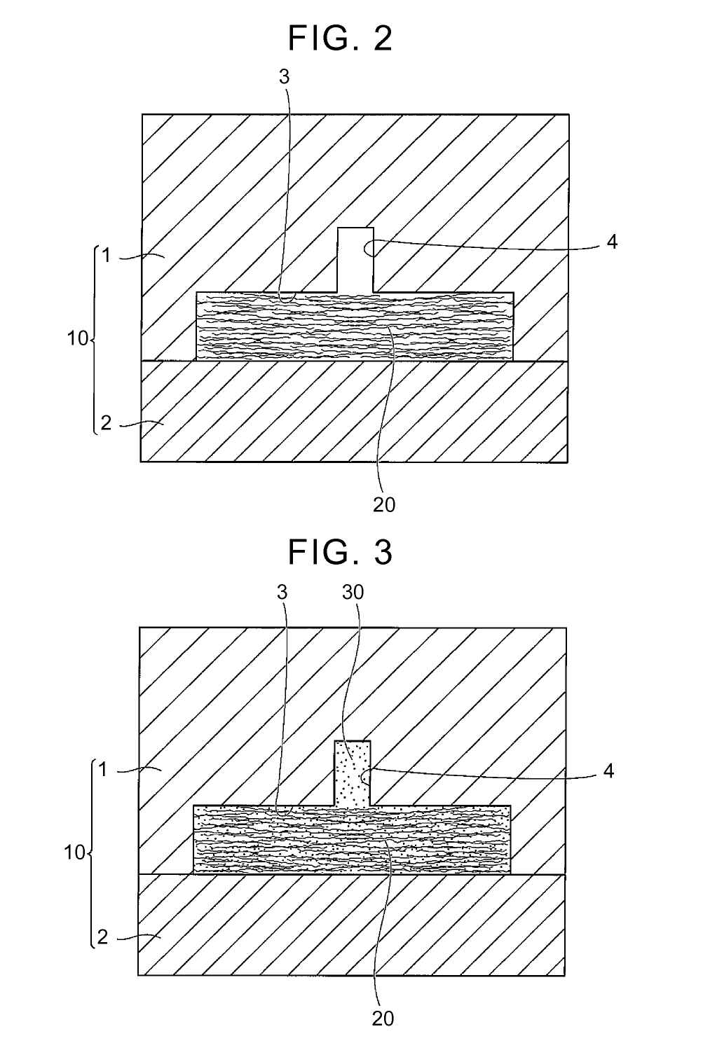

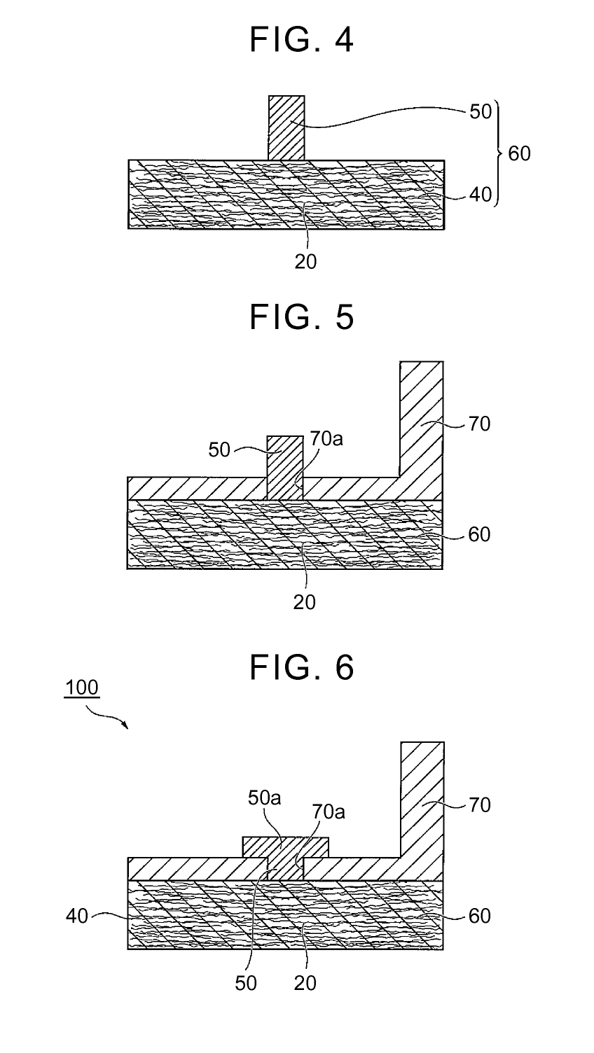

FIG. 1A to FIG. 1C show a first step of the method of connecting the members that is the first embodiment of the present invention, and show examples of molds used in the first step. FIG. 2 and FIG. 3 sequentially show a second step of the method of connecting the members. FIG. 4 is a schematic drawing showing the resin-molded composite member produced in the second step. FIG. 5 is a drawing showing a third step of the method of connecting the members, and FIG. 6 is a schematic drawing showing a connected structural body produced in the first embodiment of the present invention.

As shown in FIG. 1A, there is prepared a mold 10 that includes: an upper mold 1 and a lower mold 2 by both of which a cavity 3 is formed; and a recess 4 provided to a cavity surface that faces a cavity of the upper mold 1 (first step). A lifting mechanism to open and close the upper mold 1 is omitted in the drawings.

In the mold 10 as shown in FIG. 1A, a single recess 4 is disposed to the cavity surface of the upper mold 1, but the shape of the mold is not limited to this. Depending on the connecting manner between the two members to be eventually connected, as shown in a mold 10A of FIG. 1B, two recesses 4 may be provided to the cavity surface of an upper mold 1A. As shown in a mold 10B of FIG. 1C, the recess 4 may be disposed to the cavity surface of the upper mold 1, and a different recess 5 may also be disposed to a cavity surface of a lower mold 2A. Although not shown in the drawings, in the resin-molded composite member produced by the mold 10B as shown in

FIG. 1C, resin-molded bodies to be inserted through respective through-holes of the different member are provided on both upper and lower surfaces of a fiber-reinforced resin body that is a structural element included in the resin-molded composite member. Hereinafter, the method of connecting the members that is the first embodiment of the present invention will be described with reference to the case of using the mold 10 as shown in FIG. 1A.

As shown in FIG. 2, a fiber-reinforcing material 20 formed of a continuous-fiber-reinforcing material or a long-fiber-reinforcing material is disposed in the cavity 3 of the mold 10. The continuous-fiber-reinforcing material is a fiber material whose fiber length is 50 mm or more, and the long-fiber-reinforcing material is a fiber material whose fiber length is less than 50 mm, specifically, a fiber length of more than 10 mm to approximately 30 mm or less, for example.

The fiber-reinforcing material 20 is formed by collecting continuous reinforcing fibers and others into a shape and a dimension approximate to a shape and a dimension of the cavity 3. An example of a raw material of the fiber-reinforcing material 20 may include any one of, or a mixture of two or more of ceramic fibers made of boron, alumina, silicon carbide, silicon nitride, zirconia, or the like; inorganic fibers such as glass fibers and carbon fibers; metallic fibers made of copper, steel, aluminum, stainless steel, or the like; and organic fibers made of polyamide, polyester, or the like.

As shown in FIG. 3, a thermoplastic resin 30 is injected into the cavity 3 and the recess 4. The thermoplastic resin 30 injected therein permeates the fiber-reinforcing material 20 in the cavity 3, and then spreads across the entire cavity 3, and further spreads into the recess 4 to completely fill the recess 4.

As a raw material of the thermoplastic resin 30, it is possible to employ one of, or a material including a mixture of two or more of a crystalline plastic such as polyethylene (PE), polypropylene (PP), polyamide (PA: nylon 6, nylon 66), polyacetal (POM), and polyethylene terephthalate (PET); and an amorphous plastic such as polystyrene (PS), polyvinyl chloride (PVC), polymethylmethacrylate (PMMA), ABS resin, and thermoplastic epoxy resin.

The thermoplastic resin 30 injected in the cavity 3 and the recess 4 becomes cured, thereby producing a resin-molded composite member 60 formed of the fiber-reinforced resin molded body 40 and a resin molded body 50 (second step). The fiber-reinforced resin molded body 40 is formed of the fiber-reinforcing material 20 and the thermoplastic resin 30. The resin molded body 50 is integrated with the fiber-reinforced resin molded body 40, and includes no fiber-reinforcing material 20.

After the resin-molded composite member 60 is produced in the second step, the resin molded body 50 included in the resin-molded composite member 60 is inserted through a through-hole 70a of a metallic member 70 that is the different member to be connected to the resin-molded composite member 60, as shown in FIG. 5.

Subsequently, the resin molded body 50 is heated at a temperature of its melting point or more, and the resin molded body 50 is pressurized while being softened, thereby deforming, with pressure, a region of the resin molded body 50 upwardly projecting from the through-hole 70a into a flange 50a, as shown in FIG. 6. Furthermore, the metallic member 70 is clamped by the flange 50a and the fiber-reinforced resin molded body 40, thereby connecting the resin-molded composite member 60 and the metallic member 70 into a connected structural body 100.

According to the method of connecting the members as shown in the drawings, because the resin molded body 50 to be deformed includes no fiber-reinforcing material 20 made of a continuous-fiber-reinforcing material and others, the resin molded body 50 can easily be deformed with pressure, which facilitates the connecting work between the resin-molded composite member 60 and the metallic member 70.

No connecting components, such as adhesive, bolts, screws, and self-pierce rivets, are used for connecting the resin-molded composite member 60 and the metallic member 70, thus enhancing efficiency of the connecting work as well as attaining reduction in manufacturing cost.

Since the resin-molded composite member 60 and the metallic member 70 are connected to each other by clamping the metallic member 70 through pressurizing deformation of the resin molded body 50 and the fiber-reinforced resin molded body 40, the connecting strength of the connected structural body 100 becomes extremely high.

Plain-woven carbon fiber fabric is disposed in the cavity of the mold that includes the recess on the cavity surface. As the thermoplastic resin to be injected in the cavity, a mixture formed by adding a catalyst and an activator in E-caprolactam that is a raw material of polyamide is used. This thermoplastic resin is melted at a temperature of 100° C., and is injected into the mold. At the time of injecting this thermoplastic resin, a temperature of the mold is set to be 160° C. at which the thermoplastic resin can be polymerized. After curing of the thermoplastic resin, there is produced the resin-molded composite member including: the fiber-reinforced resin molded body formed of the carbon fiber fabric and the thermoplastic resin; and the resin molded body made of the thermoplastic resin alone that projects from the fiber-reinforced resin molded body. Subsequently, the resin molded body is inserted through the through-hole of the different member, and is then pressurized under a temperature atmosphere at 280° C. that is the melting point or more of the polymerized polyamide, thereby clamping the different member by the fiber-reinforced resin molded body and the resin molded body expanded through the pressurization.

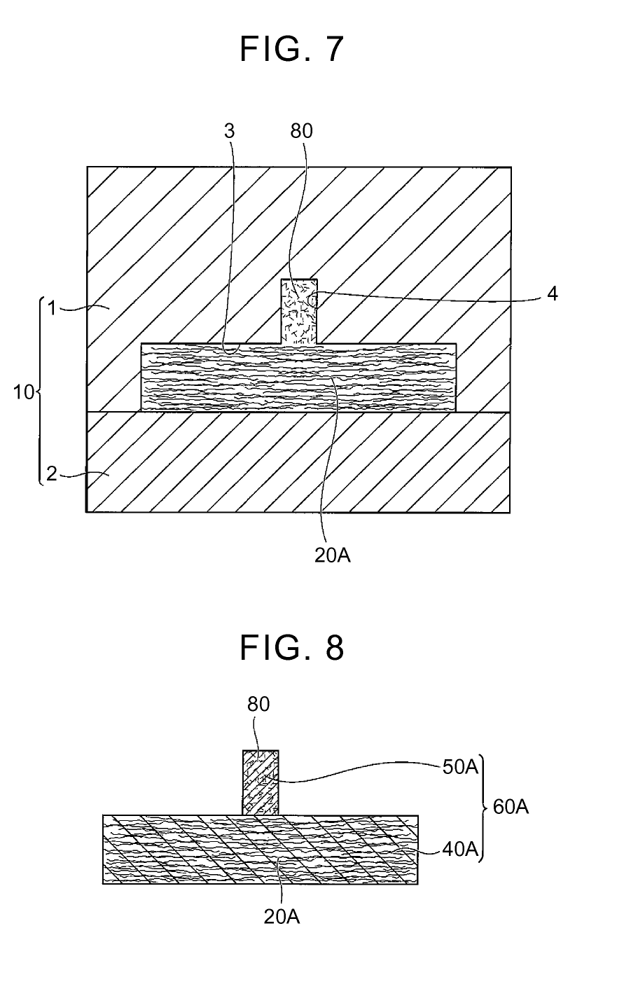

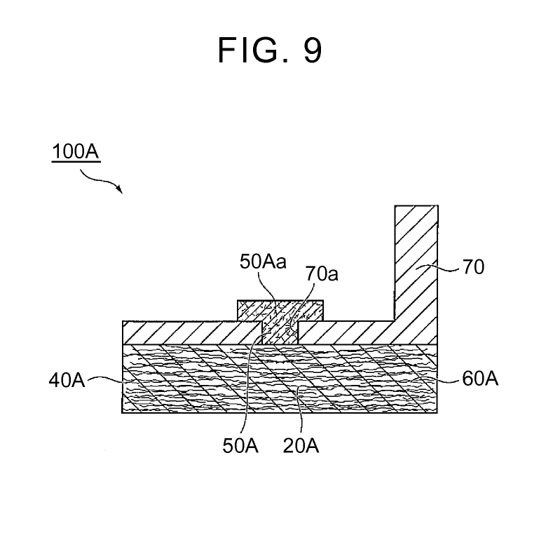

A method of connecting members that is the second embodiment of the present invention will be described with reference to FIG. 7 to FIG. 9 as below. FIG. 7 is a drawing showing a second step of the method of connecting the member that is the second embodiment of the present invention. FIG. 8 is a schematic drawing showing a resin-molded composite member produced in the second step. FIG. 9 is a schematic drawing showing the second embodiment of the produced connected structural body.

In this connecting method, as shown in FIG. 7, in the second step, in addition to disposing a first fiber-reinforcing material 20A formed of the continuous-fiber-reinforcing material or the long-fiber-reinforcing material in the cavity 3 of the mold 10, a second fiber-reinforcing material 80 formed of a short-fiber-reinforcing material is disposed in the recess 4.

Although not shown in the drawings, the cavity 3 and the recess 4 are filled with the thermoplastic resin, the injected thermoplastic resin permeates the first fiber-reinforcing material 20A in the cavity 3, and then spreads across the entire cavity 3. In the recess 4, the injected thermoplastic resin permeates the second fiber-reinforcing material 80, and then spreads across the entire recess 4 to completely fill the recess 4.

The thermoplastic resin injected in the cavity 3 and the recess 4 is cured, thereby producing a resin-molded composite member 60A formed of a first fiber-reinforced resin molded body 40A and a second fiber-reinforced resin molded body 50A (second step), as shown in FIG. 8. The first fiber-reinforced resin molded body 40A is formed of the first fiber-reinforcing material 20A and the thermoplastic resin. The second fiber-reinforced resin molded body 50A is formed of the second fiber-reinforcing material 80 integrated with the first fiber-reinforced resin molded body 40A and the thermoplastic resin.

After the resin-molded composite member 60A is produced in the second step, although not shown in the drawings, the second fiber-reinforced resin molded body 50A of the resin-molded composite member 60A is inserted through the through-hole 70a of the metallic member 70 that is a different member to be connected to the resin-molded composite member 60A.

Subsequently, the second fiber-reinforced resin molded body 50A is heated at a temperature of its melting point or more, and the second fiber-reinforced resin molded body 50A is pressurized while being softened, thereby deforming, with pressure, a region of the second fiber-reinforced resin molded body 50A projecting from the through-hole 70a into a flange 50Aa, as shown in FIG. 9. The metallic member 70 is clamped by the flange 50Aa and the first fiber-reinforced resin molded body 40A so as to connect the resin-molded composite member 60A and the metallic member 70 to each other into a connected structural body 100A.

According to the method of connecting the members as shown in the drawings, the second fiber-reinforced resin molded body 50A to be deformed includes the second fiber-reinforcing material 80 formed by the short-fiber-reinforcing material. In other words, the second fiber-reinforced resin molded body 50A includes no fiber material hard to be deformed with pressure, such as the continuous-fiber-reinforcing material.

Accordingly, according to the second embodiment of the present invention, as similar to the connecting method according to the first embodiment of the present invention, pressurizing deformation becomes easier, thus facilitating the connecting work between the resin-molded composite member 60A and the metallic member 70.

This connecting method requires no connecting components, such as adhesive, bolts, screws, and self-pierce rivets. Hence, it is possible to enhance efficiency of the connecting work as well as attain reduction in manufacturing cost. In addition, the second fiber-reinforced resin molded body 50A to be inserted through the through-hole 70a of the metallic member 70 and deformed includes the fiber-reinforcing material (second fiber-reinforcing material 80), thus further enhancing the connecting strength of the connected structural body 100A compared with the connecting strength of the connected structural body 100.

As aforementioned, the embodiments of the present invention have been described in details with reference to the drawings, but specific configurations are not limited to the above embodiments. Even if there are design changes and the like without departing from the scope of the present invention, these design changes may also be included in the present invention.

What is claimed is:

1. A method of connecting members, the method comprising:
preparing a mold including an upper mold and a lower mold by both of which a cavity is formed, a cavity surface of the upper mold or the lower mold having a recess, and the cavity surface facing the cavity;
disposing a fiber-reinforcing material formed of a continuous-fiber-reinforcing material or a long-fiber-reinforcing material in the cavity, filling the cavity and the recess with a thermoplastic resin, and curing the thermoplastic resin to produce a resin-molded composite member including a fiber-reinforced resin molded body and a resin molded body, the fiber-reinforced resin molded body being formed of the fiber-reinforcing material and the thermoplastic resin, the resin molded body being integrated with the fiber-reinforced resin molded body, and the resin molded body including no fiber-reinforcing material; and
inserting the resin molded body through a through-hole of a predetermined member, and deforming the resin molded body with pressure to clamp the predetermined member by the fiber-reinforced resin molded body and the resin molded body and to connect the resin-molded composite member and the predetermined member.

2. A method of connecting members, the method comprising:
preparing a mold including an upper mold and a lower mold by both of which a cavity is formed, a cavity surface of the upper mold or the lower mold having a recess, and the cavity surface facing the cavity;
disposing a first fiber-reinforcing material formed of a continuous-fiber-reinforcing material or a long-fiber-reinforcing material in the cavity, disposing a second fiber-reinforcing material formed of a short-fiber-reinforcing material in the recess, filling the cavity and the recess with a thermoplastic resin, and curing the thermoplastic resin to produce a resin-molded composite member including a first fiber-reinforced resin molded body and a second fiber-reinforced resin molded body, the first fiber-reinforced resin molded body being formed of the first fiber-reinforcing material and the thermoplastic resin, the second fiber-reinforced resin molded body being integrated with the first fiber-reinforced resin molded body, and the second fiber-reinforced resin molded body being formed of the second fiber-reinforcing material and the thermoplastic resin; and
inserting the second fiber-reinforced resin molded body through a through-hole of a predetermined member, and deforming the second fiber-reinforced resin molded body with pressure to clamp the predetermined member by the first fiber-reinforced resin molded body and the second fiber-reinforced resin molded body and to connect the resin-molded composite member and the predetermined member.
